(19) United States
(12) Patent Application Publication
(10) Pub. No.: US 2020/0022853 A1
(43) Pub. Date: Jan. 23, 2020

(54) FOLDING ALL-TERRAIN ELECTRIC WHEELCHAIR

(71) Applicant: ALEJANDRO ROTH BURELA, MADRID (ES)

(72) Inventor: ALEJANDRO ROTH BURELA, MADRID (ES)

(21) Appl. No.: 16/191,521

(22) Filed: Nov. 15, 2018

(30) Foreign Application Priority Data
Jul. 19, 2018 (ES) U201831157

(51) Int. Cl. A61G 5/08; A61G 5/06; A61G 5/04

(52) U.S. Cl. CPC A61G 5/0866; A61G 5/045; A61G 5/06

(57) ABSTRACT

The invention relates to a folding all-terrain electric wheelchair comprising: A triangular support structure (1) provided with two rear wheels (2), traction motors (3) joined to the rear wheels (2), at least two batteries (4), a chair formed by a removable seat (5) and a folding back (8), folding armrests (6) joined to the back (8), a remote or joystick (7), a hinged joint (10) arranged on the free end of the support structure (1) and which enables the assembly and fastening of either an urban wheel (11) or an all-terrain wheel (12), an anti-tipping assembly (15) fastened to the bearing structure (1) and suspension means (16) of the seat. A chair is achieved which is able to be used with maximum comfort on rough terrain, in urban areas, to be folded, to be transported very easily, and has symmetric and asymmetric suspension means, and a very light final weight.

### OBJECT OF THE INVENTION

The object of the present invention, as established by the title of the invention, is a wheelchair that is electric, which furthermore can be an all-terrain chair, and which can be folded for improved storage and transportation.

The present invention is the result of the combination and adaptation of different constructive elements, duly designed such that a wheelchair is achieved which offers the dual possibility of operating as a wheelchair in the city as well as on rugged or soft terrain propelled by two electric motors powered by rechargeable batteries.

Therefore, the present invention falls within the field of electric wheelchairs.

### BACKGROUND OF THE INVENTION

A wheelchair with electric propulsion equipped with batteries with a tricycle format actuated by the user by using a joystick. It is an adapted chair that has at least three wheels and that can be actuated manually by the user or by a third party who pushes it, or it can be autonomous since it has batteries.

Currently there are several designs of electric all-terrain vehicles for the disabled in order to thus provide them with greater freedom of locomotion.

The current all-terrain electric wheelchairs available on the market weigh more than 100 kg, are dimensionally larger in size, cannot be folded or reconfigured for urban use, or have elements that hinder the handling, moving and operation thereof for the majority of the disabled. The all-terrain electric wheelchairs listed previously also do not have asymmetric-symmetric suspension (lateral inclination) for the seat, design elements which provide greater comfort to the user.

Therefore, the object of the present invention is to overcome the noted disadvantages of excess weight, lack of convertibility into chairs for urban movement, lack of improvements for handling, both in the transportation and storage thereof and lack of suspension means, developing an all-terrain electric chair such as that which is described below and whose essential nature is expressed in the first claim.

### DESCRIPTION OF THE INVENTION

The object of the present invention is an all-terrain electric wheelchair that can fold and is lightweight, for which reason, and thanks to the configurability thereof, the chair is able to be used in the countryside and in the city.

The chair is completely and preferably made of aluminum and stainless steel, it has a tricycle configuration and triangular structure that is further equipped with asymmetric-symmetric suspension for the seat, and is able to be reconfigured for urban use and can be vertically folded in order to facilitate the movement and storage thereof.

The wheelchair is propelled by two high-torque motors with built-in electromagnetic brakes, coupled to the respective floating wheels and ample tread area thereof to thus exert a minimum pressure per square centimeter on soft and rough terrains and furthermore provide optimal traction. The speed, direction and braking are controlled by means of a joystick.

The rotating front wheel with a large diameter enables the movement thereof on rough terrain or sandy surfaces and is secured by a vertically articulated fork which in turn can be folded or removed.

In order to achieve the operating reconfiguration from a rural to an urban setting, a second rotating wheel with a smaller diameter located and fastened with removable pins in the upper portion of the stainless-steel master hinge (the articulation point of the wheel with a larger diameter with the fork thereof plus the bearing structure thereof) enables the transfer and fastening thereof by means of the respective quick-removal pins to the lower portion of the indicated hinge and in replacement of the wheel with a larger diameter.

The possibility of the quick removal of the wheel with a larger diameter also considerably reduces the total length of the electric wheelchair for better urban performance.

The back of the seat and furthermore the anti-tipping rear wheels can also fold. The anti-tipping wheels that limit longitudinal tilting are equipped with shock-absorbers and the indicated assembly is able to be reconfigured by means of the quick removal of pins built into the bearing arm thereof in order to thus convert it into the unidirectional transporter thereof when the wheelchair is positioned vertically in order to facilitate the transfer thereof.

The wheelchair can have an accessory that is able to be coupled to the folded chair and is equipped with four rotating wheels. The electric wheelchair is also supplied with an emergency drawbar and an anti-tipping stainless-steel bar that can be inserted in the back of the seat.

The electric wheelchair is equipped with a seat with symmetrical and asymmetrical suspension and up to 9 cm of vertical movement; the design incorporates two torque-multiplying arms made of stainless steel and mounted on bearings. The indicated design enables the respective lateral tilting of the seat to additionally absorb the lateral or asymmetrical impacts caused by the vertical movement over the terrain caused by one of the main traction wheels.

The reduced total weight of approximately 70 kg of the electric wheelchair has been achieved by the triangular structural design with a core in a T-shaped configuration made entirely out of extruded square tubular aluminum and high-strength sheets and complementary elements made of stainless steel.

The batteries used are high-capacity low-weight Lithium Ion, combined with the tricycle-format rolling design and aluminum structure with the least number of structural elements and they are the main factors contributing to the very low weight thereof.

Therefore, thanks to the features described an electric wheelchair is achieved which:
Enables it to be used with maximum comfort on rough terrain.
Enables it to be used in urban areas by only removing the all-terrain wheel and placing the wheel for urban use.
Enables the chair to be folded, both the seat as well as the back such that it occupies a reduced space for storage and transportation
Enables it to be transported very easily once folded, thanks to the anti-tipping system.
Has symmetric and asymmetric suspension means which provide the chair with good stability.
Has a very light final weight.

Except when indicated otherwise, all of the technical and scientific elements used in this specification have the meaning commonly understood by one with average skill in the art to which this invention belongs. When this invention is put into practice, methods and materials may be used that are similar or equivalent to the ones described in this specification.

Throughout the description and the claims, the term “comprises” and its variants do not aim to exclude other technical features, additions, components or steps. For those skilled in the art, other objects, advantages and features of the invention may be deduced from both the description and the practical use of the invention.

### BRIEF DESCRIPTION OF DRAWINGS

As a complement to the present description, and for the purpose of helping to make the features of the invention more readily understandable, in accordance with a preferred practical exemplary embodiment thereof, said description is accompanied by a set of drawings constituting an integral part of the same, which by way of illustration and not limitation represent the following.

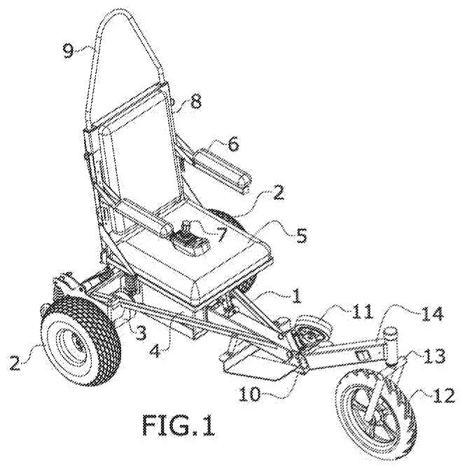

In FIG. 1 we can see an isometric representation of the chair in its entirety.

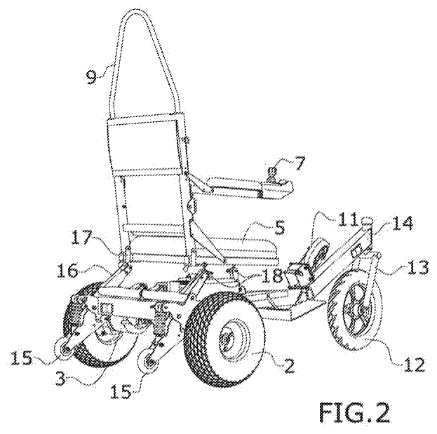

In FIG. 2 we can see an isometric representation of a rear view of the chair.

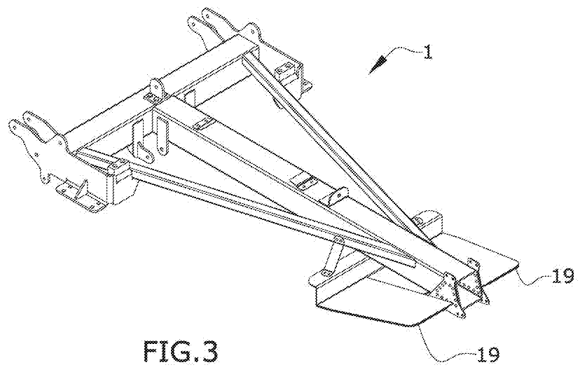

In FIG. 3 we can see a representation of the isometric support structure.

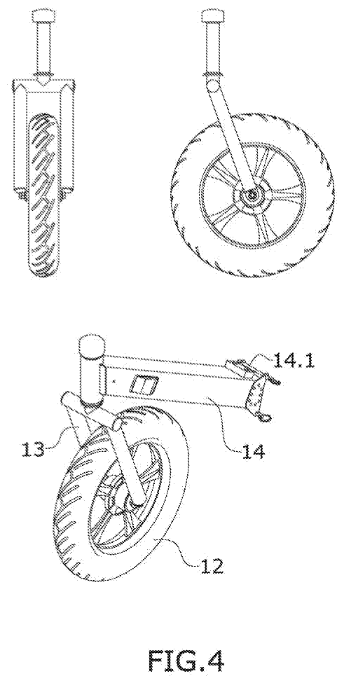

In FIG. 4 three different views of the all-terrain wheel and the bearing structure thereof are shown.

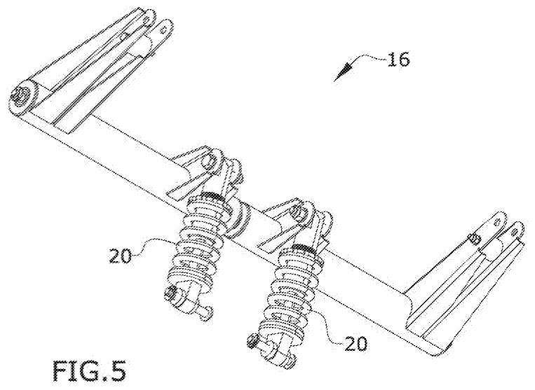

In FIG. 5 the suspension means of the chair are shown.

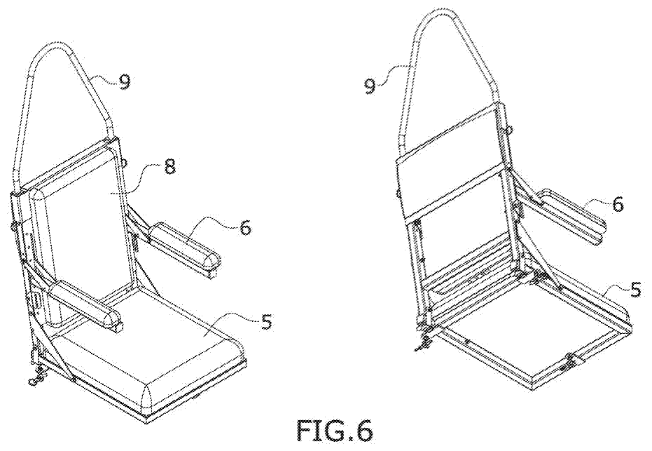

In FIG. 6 the different views of the seat and back of the chair are shown.

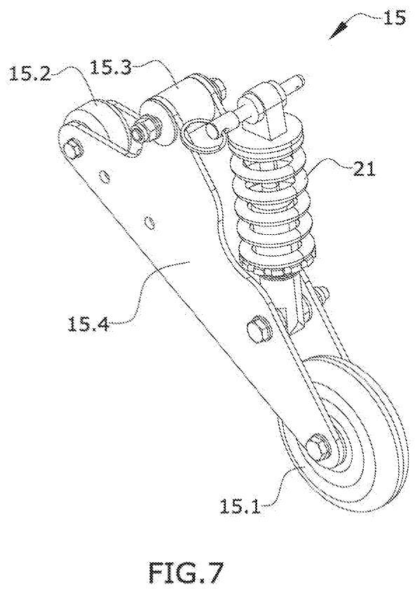

In FIG. 7 the anti-tipping assembly is shown.

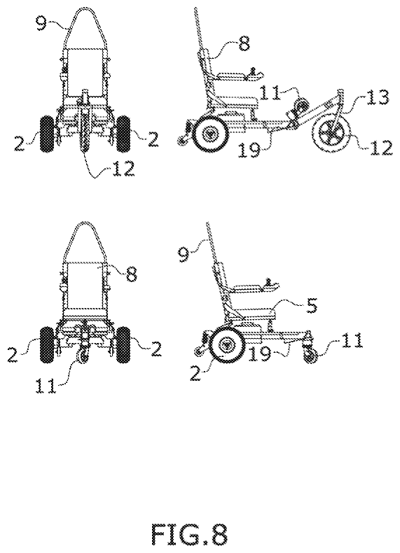

In FIG. 8 front and side views of the chairs prepared for urban and all-terrain use are shown.

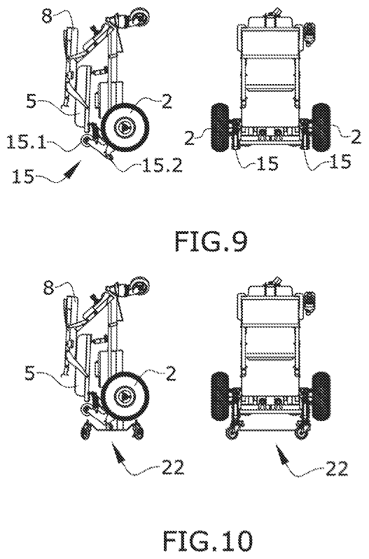

In FIG. 9 the folded chair is shown in side and plan view for urban use.

In FIG. 10 the folded chair is shown in side and plan view for urban use arranged on the movement accessory.

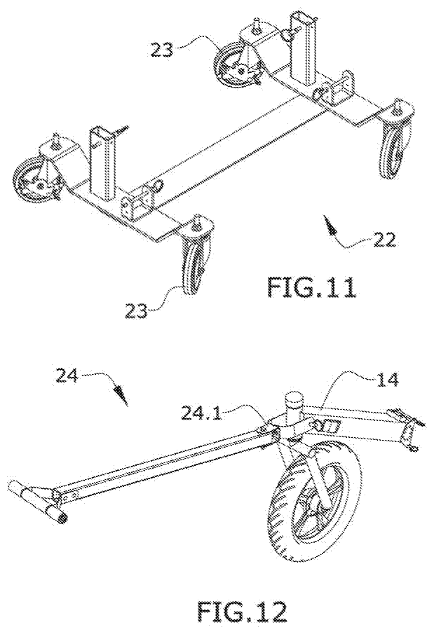

In FIG. 11 a detail of the movement accessory is shown.

In FIG. 12 the drawbar is shown.

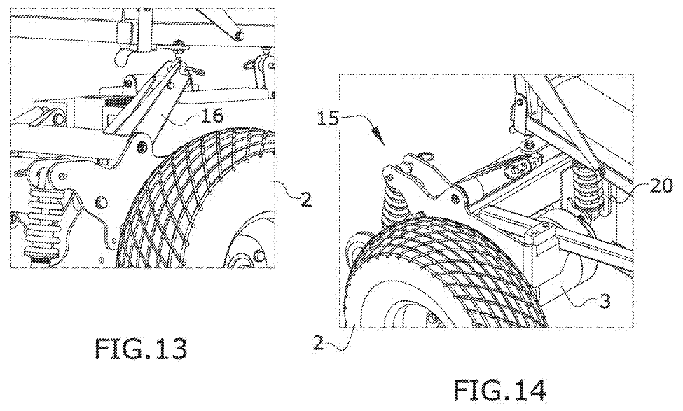

In FIGS. 13 and 14 details of the suspension and traction are shown.

### PREFERRED EMBODIMENT OF THE INVENTION

With reference to the figures, below a preferred embodiment of the invention proposed is described.

In FIG. 1 we can see that the all-terrain electric chair comprises:
A triangular support structure (1)
Two rear wheels (2) coupled to the support structure (1)
Traction motors (3) joined to the rear wheels (2)
At least two batteries (4) to power the motors and that are supported by the support structure (1)
A chair formed by a removable seat (5) and a folding back (8)
Folding armrests (6) joined to the back (8)
A remote or joystick (7) arranged in a folding armrest (6)
A hinged joint (10) arranged on the free end of the support structure (1) and which enables the assembly and fastening of either an urban wheel (11) or an all-terrain wheel (12).

Optionally, a push bar (9) can be arranged on the folding back (8).

The all-terrain wheel (12) is joined to the chair by means of a bearing structure (14) which on one of the ends thereof is joined to the hinged joint (10) and on the other end to a fork (13) wherein the all-terrain wheel (12) is mounted.

In FIG. 2 it is worth noting how the chair has an anti-tipping assembly (15) fastened to the bearing structure (1) and how, furthermore, the seat has suspension means (16).

Also, the seat (5) has fasteners (17) and quick-release locking pins (18) which enable the fastening of the seat to be released with respect to the support structure.

In FIG. 3 the support structure (1) is shown which in a possible embodiment has a core in a T-shaped configuration made entirely out of extruded square tubular aluminum and high-strength sheets of the 6061 T6 type and complementary elements made of 304 stainless steel.

On the front end or vertex of the support structure (1) a footrest (19) is arranged, with the aim of achieving better distribution of the pressure exerted by the feet on the terrain.

In FIG. 4 it is worth noting how on the free end of the bearing structure (14) of the all-terrain wheel (12), a pin (14.1) is arranged which acts to fasten the previous assembly on the support structure (1).

In FIG. 5 it is seen that the shock-absorbing assembly has shock absorbers (20), which make the use of the chair more comfortable especially when operating as an all-terrain chair.

In FIG. 7 the anti-tipping assembly (15) comprises a structure (15.4) on which three wheels are mounted, a first wheel (15.1), a second wheel (15.2) and a third wheel (15.3), and it also has a shock-absorbing spring (21).

Furthermore, said anti-tipping assembly (15) tilts with respect to the support structure (1) and acts to move the assembly of the seat when it is folded.

In FIG. 8 the chair is shown both in the configuration thereof to be used as an urban chair and as an all-terrain chair, where the urban wheel (11) has been moved for the all-terrain wheel (12).

In FIGS. 9 and 10 the folded chair is seen in two views, being distinguished by the fact that in FIG. 10 it is arranged on a movement accessory. In FIG. 9 the anti-tipping assembly (15) is not tilted such that the entire chair, once folded, is supported by the wheels (15.1) and (15.2).

In FIG. 11 the accessory or cart for the movement (22) is shown, wherein the chair is fastened and acts to move the entire chair once folded and it has a configuration in a double-T shape and has wheels (23) on each end.

In FIG. 12 a drawbar (24) is shown that is able to be coupled on the end of the bearing structure (14) joined by means of an anti-tipping joint (24.1) which has two degrees of freedom in the joint thereof with the bearing structure (14) and which prevents the chair pulled from the drawbar (24) from being tipped over.

In FIGS. 13 and 14 details are shown of the suspension and traction motor (3) described previously.

Having thus adequately described the nature of the present invention, as well as how to put it into practice, it must be noted that, within its essential nature, the invention may be carried out according to other embodiments differing in detail from that set out by way of example, which the protection sought would equally cover, provided that the fundamental principle thereof is not altered, changed or modified.

1. A folding all-terrain electric wheelchair comprising:
a triangular support structure;
two rear wheels coupled to the support structure;
traction motors joined to the rear wheels;
at least two batteries to power the motors and that are supported by the support structure;
a chair formed by a removable seat and a folding back;
folding armrests joined to the back;
a remote or joystick arranged in a folding armrest;
a hinged joint arranged on the free end of the support structure and which enables the assembly and fastening of either an urban wheel or an all-terrain wheel;
an anti-tipping assembly fastened to the bearing structure;
suspension means of the seat.

2. The folding all-terrain electric wheelchair according to claim 1, wherein the all-terrain wheel (12) is joined to the chair by means of a bearing structure (14) which on one of the ends thereof is joined to the hinged joint (10) and on the other end to a fork (13) wherein the all-terrain wheel (12) is arranged.

3. The folding all-terrain electric wheelchair according to claim 1, wherein the seat (5) has fasteners (17) and quick-release locking pins (18).

4. The folding all-terrain electric wheelchair according to claim 1, wherein on the front end or vertex of the support structure (1) a footrest (19) is arranged.

5. The folding all-terrain electric wheelchair according to claim 1, wherein on the free end of the bearing structure (14) of the all-terrain wheel (12), a pin (14.1) is arranged which acts to fasten the previous assembly on the support structure (1).

6. The folding all-terrain electric wheelchair to claim 1, wherein the shock-absorbing assembly (16) has shock absorbers (20).

7. The folding all-terrain electric wheelchair to claim 1, wherein the anti-tipping assembly (15) comprises a structure (15.4) on which three wheels are mounted, a first wheel (15.1), a second wheel (15.2) and a third wheel (15.3), and it also has a shock-absorbing spring (21).

8. The folding all-terrain electric wheelchair according to claim 1, wherein a push bar (9) is arranged on the folding back (8).

9. The folding all-terrain electric wheelchair according to claim 1, wherein the wheelchair has an accessory for the movement (22) which has a configuration in a double-T shape and which has wheels (23) on each end.

10. The folding all-terrain electric wheelchair according to claim 1, wherein the wheel chair has a pulling accessory consisting of a drawbar (24) that can be coupled on the end of the bearing structure (14) joined by means of an anti-tipping joint (24.1) which has two degrees of freedom in the joint thereof with the bearing structure (14).
